(19) United States
(12) Patent Application Publication
(10) Pub. No.: US 2024/0385810 A1
(43) Pub. Date: Nov. 21, 2024

(54) CODE GENERATION METHOD AND MEDIUM

(71) Applicant: Beijing Zitiao Network Technology Co., Ltd., Beijing (CN)

(72) Inventor: Junyu Yue, Beijing (CN)

(21) Appl. No.: 18/665,323

(22) Filed: May 15, 2024

(30) Foreign Application Priority Data
May 15, 2023 (CN) 202310541545.2

(51) Int. Cl. G06F 8/33; G06F 8/41; G06F 8/73

(52) U.S. Cl. CPC G06F 8/33; G06F 8/42; G06F 8/73

(57) ABSTRACT

Embodiments of the present disclosure provide a code generation method and apparatus, a device and a medium. A specific implementation of the method includes: in response to opening a first file corresponding to a code to be detected, determining a target element corresponding to a target annotation included in the code to be detected; and generating a corresponding target code according to the target annotation and the target element.

### CROSS-REFERENCE TO RELATED APPLICATION

This application claims priority to Chinese Application No. 202310541545.2 filed May 15, 2023, the disclosure of which is incorporated herein by reference in its entity.

### FIELD

Embodiments of the present disclosure relate to the technical field of code analysis and code generation, and in particular to a code generation method and a medium.

### BACKGROUND

Existing code generation solutions often automatically generate codes via annotation processing tools. The annotation processing tool (APT) is a processing tool for code annotation, which finds annotation information contained in a source code by detecting a source code file, and then processes the annotation information, for example, generates additional codes according to the annotation information. These additional codes may generally be automatically generated and integrated into an overall code of a project in a compilation process of the source code file, thereby reducing the workload of a software engineer and accelerating the development speed of the codes. However, since the additional codes are generated in the compilation process, it is often necessary to obtain the generated additional codes after the compilation process of the entire software is completed. However, in some software production scenarios, it is expected to refer the content in the additional codes in the codes before the software is compiled, which may result in a large number of wrong reference prompts, thus affecting the debugging of the codes by the software engineer, and this problem cannot be solved by the existing code generation solutions.

Therefore, there is a need for a new code generation method.

### SUMMARY

Embodiments of the present disclosure describe a code generation method and apparatus, a device and a medium.

According to a first aspect, a code generation method is provided, including:
in response to opening a first file corresponding to a code to be detected, determining a target element corresponding to a target annotation included in the code to be detected; and
generating a corresponding target code according to the target annotation and the target element.

According to a second aspect, a code generation method is provided, including:
in response to a change to a code to be detected, determining whether the change is directed to a target element corresponding to a target annotation; and
in response to the change is directed to the target element corresponding to the target annotation, updating, according to the changed target element, a target code corresponding to the target annotation and the target element.

According to a third aspect, a code generation apparatus is provided, including:
a first response unit, configured to: in response to opening a first file corresponding to a code to be detected, determine a target element corresponding to a target annotation included in the code to be detected; and
a first generation unit, configured to generate a corresponding target code according to the target annotation and the target element.

According to a fourth aspect, a code generation apparatus is provided, including:
a second response unit, configured to: in response to a change to a code to be detected, determine whether the change is directed to a target element corresponding to a target annotation; and
a second generation unit, configured to: in response to the change is directed to the target element corresponding to the target annotation, update, according to the changed target element, a target code corresponding to the target annotation and the target element.

According to a fifth aspect, a computer-readable storage medium storing a computer program thereon is provided, wherein when the computer program is executed in a computer, the computer is caused to execute the first aspect and the method in the second aspect.

According to a sixth aspect, an electronic device is provided, including a memory and a processor, wherein an executable code is stored in the memory, and the processor implements, when executing the executable code, the method in the first aspect and the second aspect.

According to the embodiments of the present disclosure, a code generation method and apparatus, a device and a medium are provided. In response to opening the first file corresponding to the code to be detected, the target element corresponding to the target annotation included in the code to be detected may be determined. Then, the corresponding target code is generated according to the target annotation and the target element. By using any one of the above method and apparatus, the storage medium and the electronic device, before an annotation-containing code is compiled, the target code corresponding to the annotation and the target element of the annotation may be generated, so that the content of the target code may be referenced in the annotation-containing code without generating wrong application information.

### BRIEF DESCRIPTION OF THE DRAWINGS

FIG. 1 illustrates a schematic diagram of prompting wrong reference resulted by referencing generation code;

FIG. 2 illustrates a schematic diagram of a code generation method according to an embodiment of the present disclosure;

FIG. 3 illustrates a schematic flowchart of a code generation method according to an embodiment of the present disclosure;

FIG. 4 illustrates a schematic flowchart of a code generation method according to another embodiment of the present disclosure;

FIG. 5 illustrates a schematic block diagram of a code generation apparatus according to an embodiment of the present disclosure;

FIG. 6 illustrates a schematic block diagram of a code generation apparatus according to another embodiment of the present disclosure;

FIG. 7 illustrates a schematic structural diagram of an electronic device suitable for implementing embodiments of the present disclosure; and

FIG. 8 illustrates a schematic structural diagram of a storage medium suitable for implementing embodiments of the present disclosure.

### DETAILED DESCRIPTION OF EMBODIMENTS

The technical solutions provided in the present specification are further described in detail below in combination with the drawings and embodiments. It can be understood that the specific embodiments described herein are merely used for explaining related invention, rather than limiting the invention. In addition, it should be noted that, for ease of description, only parts related to the related invention are shown in the drawings. It should be noted that, in the case of no conflict, embodiments of the present disclosure and features in the embodiments may be combined with each other.

In the description of implementations of the present disclosure, the term “include” and similar terms should be understood as open-ended inclusion, that is, “including, but not limited to”. The term “based on” should be understood as “based, at least in part, on”. The term “a implementation” or “the implementation” should be understood as “at least one implementation”. The term “some implementations” should be understood as “at least some implementations”. Other explicit and implicit definitions may also be included below.

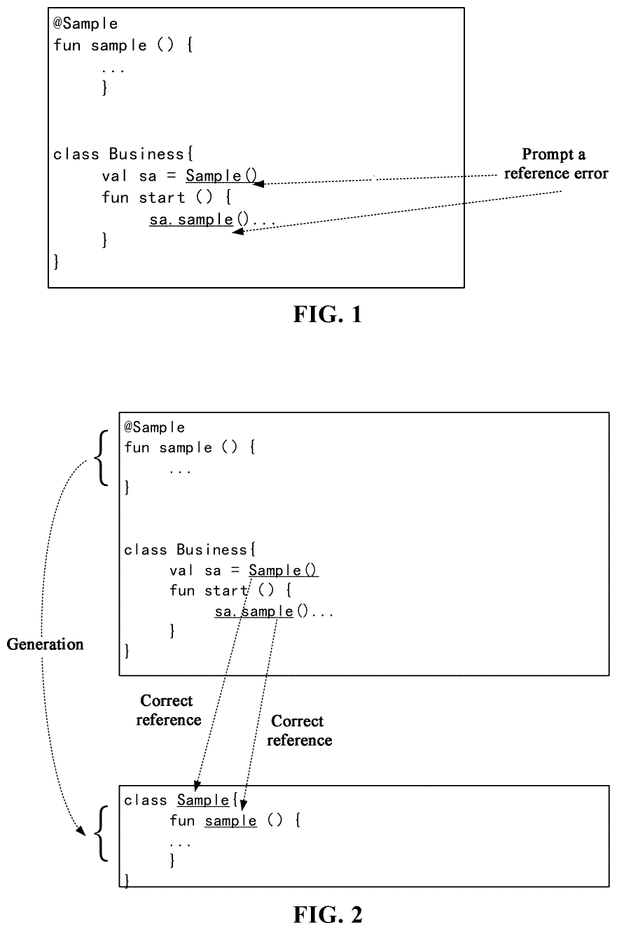

As described above, existing code generation solutions often automatically generate codes via annotation processing tools. The annotation processing tool finds annotation information contained in a source code file by detecting the source code file, and then processes the annotation information, for example, generates additional codes according to the annotation information. These additional codes may generally be automatically generated and integrated into an overall code of a project in a compilation process of the source code file. However, the code generation solutions have the following problems: since the annotation processing tool generates the additional codes in the compilation process, the generated additional codes are obtained only after the compilation process of the entire software is completed. However, in some software production scenarios, it is expected to refer the content in the additional codes in the codes before the software is compiled. For example, in a scenario, for example, software development and software compilation are performed on different terminals or servers, for example, software development is performed on a work terminal of a software engineer, while software compilation is performed on a cloud server, if the software engineer expects to refer the content in the additional codes prior to the cloud compilation of the software, but the additional codes are not generated in fact prior to the compilation, so that a large amount of wrong reference information is displayed in a development environment on the terminal of the software engineer, and these pieces of wrong reference information bring inconvenience to program debugging of the software engineer. FIG. 1 illustrates a schematic diagram of prompting wrong reference resulted by referencing generation code. For example, a code to be detected includes an annotation “@ sample” and a target element fun sample ( ) of the annotation, and in a compilation phase, the annotation processing tool generates a corresponding class (e.g., class Sample) according to the annotation and the target element. However, prior to compilation, none of the class Sample and a member function contained therein is actually generated. Thus, reference thereto, for example, reference to the class Sample ( ) and the reference to a member function sa.sample ( ) of an instance (or referred to as an object) sa of the class result in reference error information.

In order to solve the above technical problems, an embodiment of the present disclosure provides a code generation method. In some embodiments, before a code to be detected is compiled, for example, when a code file of the code to be detected is opened, a target element corresponding to a target annotation included in the code to be detected is determined. Then, a corresponding target code is generated according to the target annotation and the target element. In some other embodiments, after the code to be detected is updated, it is determined whether a change is directed to the target element corresponding to the target annotation, if so, the target code corresponding to the target annotation and the target element are updated according to the changed target element. The method has the advantages that, before the annotation-containing code is complied, for example, when the code file is opened, the target code corresponding to the annotation and the target element of the annotation is generated or updated. Therefore, there is no need to wait for the compilation of the code, the content in the target code corresponding to the annotation and the target element of the annotation may be referenced in the annotation-containing code without generating wrong reference information, and thus a coder can conveniently debug the code. FIG. 2 illustrates a schematic diagram of a code generation method according to an embodiment of the present disclosure. As shown in FIG. 2, for example, a code to be detected includes an annotation “@ sample” and a target element fun sample ( ) of the annotation. Prior to the compilation phase, a corresponding class (e.g., class Sample) may be generated according to the annotation and the target element. Therefore, prior to the compilation phase, the class may be referenced, for example, via Sample ( ) or a member function sa.sample ( ) of an instance sa of the class may be referenced without generating reference error information.

A detailed process of the method is further described below.

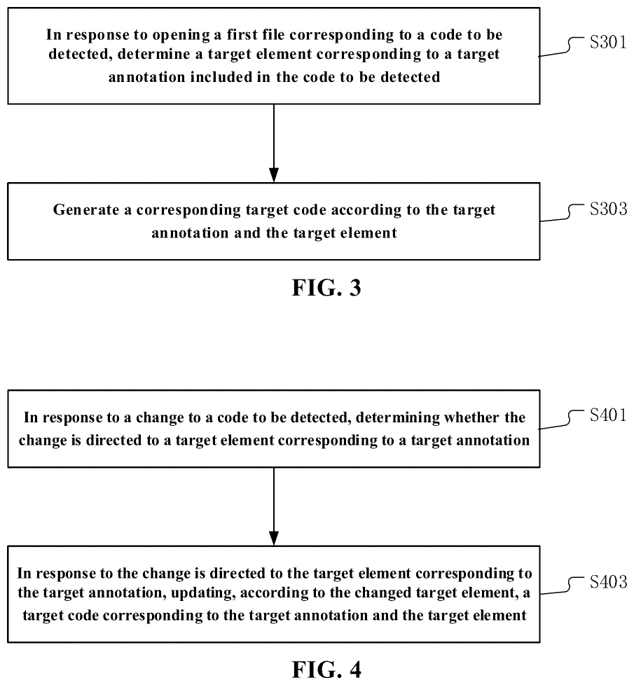

FIG. 3 illustrates a schematic flowchart of a code generation method according to an embodiment of the present disclosure. As shown in FIG. 3, the method includes at least the following steps:

Step S301, in response to opening a first file corresponding to a code to be detected, determining a target element corresponding to a target annotation included in the code to be detected; and

Step S303, generating a corresponding target code according to the target annotation and the target element.

First, in the step S301, in response to opening the first file corresponding to the code to be detected, the target element corresponding to the target annotation included in the code to be detected is determined. In the step, when the first file to which the code to be detected belongs is opened, the code element corresponding to the annotation in the code to be detected may be determined. To facilitate reference, prior to compilation, to the target code generated in subsequent steps, in an embodiment, the first file may be opened before the first file is compiled. In an embodiment, for example, specifically, when the first file is opened for the first time, the code element corresponding to the annotation in the code to be detected may be determined.

In different embodiments, the code to be detected may be program codes of different software products or applications, or program codes used for different specific purposes. In an example, for example, the code to be detected is a program source code. In different embodiments, the code to be detected may also be program codes written on the basis of different programming languages, which is not limited in the present specification. In different embodiments, the first file may include different types of specific files. In an embodiment, the first file may include one or more of a software project file, a software engineering file and a software code file. An integrated development environment (IDE) is an application program for providing a program development environment, and generally, integrated development environment may be software or software suite, which integrates a code writing function, an analysis function, a debugging function and the like. Therefore, in an embodiment, the first file corresponding to the code to be detected may be opened in the integrated development environment. In different specific embodiments, the specific integrated development environment used may be different, which is not limited in the present specification.

Annotations are special markers in the code, these marks may be read during compiling, loading and running the code, and execute respective processing. By means of the annotations, supplemental information may be embedded into the source code without changing an original code or logic. As described above, in different embodiments, the code to be detected may be based on different programming languages, and may have different specific annotation types in different programming languages. Therefore, in different embodiments, the type of the target annotation may be different specific annotation types in different specific programming languages, which is not limited in this specification. In different embodiments, the types of the target annotation may also be embedded annotation types of different specific programming languages, or user-defined annotation types according to language specifications of different specific programming languages.

The target element is a code element marked by the target annotation in the code to be detected. In different embodiments, the target element may be different specific code elements. In different embodiments, the target element may include one or more of a class, a function, an attribute, and a variable.

An abstract syntax tree (AST), or referred to as a syntax tree for short, is an abstract representation of a source code syntax structure. It represents a syntax structure of a programming language in a tree-like form, and each node on the tree represents a structural element in the source code, such as a function, a variable, an expression, and the like. Therefore, in an embodiment, the target element corresponding to the target annotation included in the code to be detected may be determined according to the abstract syntax tree corresponding to the code to be detected. In the above embodiment of opening the code to be detected in the integrated development environment, the abstract syntax tree corresponding to the code to be detected may be acquired by the integrated development environment. As described above, the programming languages of the code to be detected in different embodiments may be different. Therefore, in different embodiments, the acquired abstract syntax tree corresponding to the code to be detected may be abstract syntax trees corresponding to different programming languages, which is not limited in the present specification.

Then, in the step S303, the corresponding target code is generated according to the target annotation and the target element. In the step, the target code corresponding to the target annotation and the target element may be generated according to the target element determined in the step S301.

As described above, in different embodiments, the target annotation may be embedded annotations of different specific programming languages, or user-defined annotations according to the language specifications of different specific programming languages. In different embodiments, the embedded annotations of different specific programming languages or the user-defined annotations according to the language specifications of different specific programming languages may correspond to different predetermined code generation logic. Therefore, in different embodiments, the target annotation may correspond to different predetermined code generation logic, which is not limited in the present specification. Therefore, in an embodiment, the target code may be determined according to predetermined code generation logic corresponding to the target element, and the target element. For example, as shown in FIG. 2, for example, the annotation “@Sample” has predetermined code generation logic, that is, a class corresponding to the annotation is generated, and a member function corresponding to the target element (function) of the annotation is constructed in the class. Specifically, for example, a class Sample may be generated, and a member function Sample.sample( ) corresponding to a target element (function) fun sample ( ) of the annotation is constructed in the class Sample.

In the embodiment of opening the code to be detected by the integrated development environment, after the target code is generated, the target code may be stored in a second file. Then, the second file is refreshed in a virtual file system associated with the integrated development environment, so that the code to be detected opened in the integrated development environment may refer the target code in the second file without generating a reference error. In another specific embodiment, the steps S301 to S303 may also be executed by the integrated development environment or a plug-in of the integrated development environment.

FIG. 4 illustrates a schematic flowchart of a code generation method according to another embodiment of the present disclosure. As shown in FIG. 4, the method includes at least the following steps:

Step S401, in response to a change to a code to be detected, determining whether the change is directed to a target element corresponding to a target annotation.

In the step, after the code to be detected is changed, it is determined whether the change is directed to the target element corresponding to the target annotation in the code to be detected. In an embodiment, according to a change event of the code to be detected, it may be determined whether the change is directed to the target element corresponding to the target annotation in the code to be detected. In addition, the code to be detected, the target annotation and the target element are similar to the code to be detected, the target annotation and the target element in step S301, detailed description may refer to the description in the step S401, and thus details are not repeated herein again.

Step S403, in response to the change is directed to the target element corresponding to the target annotation, updating, according to the changed target element, a target code corresponding to the target annotation and the target element. In the step, in response to it is determined that the change is directed to the target element corresponding to the target annotation, the target code may be updated according to the changed target element. For example, in the embodiment shown in FIG. 2, for example, after it is determined that a function body included in the target element fun sample ( ) marked by the target annotation “@Sample” is modified, the target code may be changed, and specifically, the function body of the member function Sample.sample( )of the class Sample may be changed.

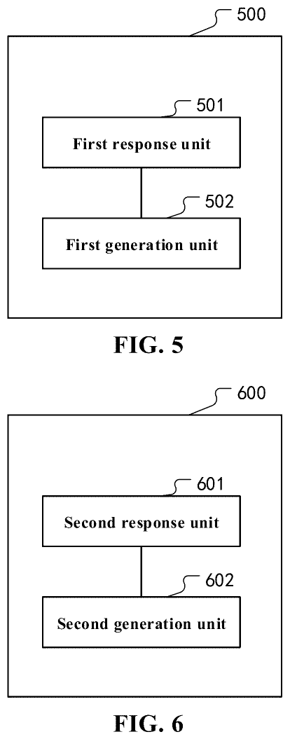

An embodiment of the present disclosure further provides an electronic device. FIG. 5 illustrates a schematic block diagram of a code generation apparatus according to an embodiment of the present disclosure. The apparatus is used for executing the method shown in FIG. 3, and as shown in FIG. 5, the apparatus 500 includes:
a first response unit 501, configured to: in response to opening a first file corresponding to a code to be detected, determine a target element corresponding to a target annotation included in the code to be detected; and
a first generation unit 502, configured to generate a corresponding target code according to the target annotation and the target element.

FIG. 6 illustrates a schematic block diagram of a code generation apparatus according to another embodiment of the present disclosure. The apparatus is used for executing the method shown in FIG. 4, and as shown in FIG. 6, the apparatus 600 includes:
a second response unit 601, configured to: in response to a change to a code to be detected, determine whether the change is directed to a target element corresponding to a target annotation; and
a second generation unit 602, configured to: in response to the change is directed to the target element corresponding to the target annotation, update, according to the changed target element, a target code corresponding to the target annotation and the target element.

An embodiment of the present disclosure further provides an electronic device, including a memory and a processor, wherein an executable code is stored in the memory, and the processor implements, when executing the executable code, the method shown in FIG. 3 and FIG. 4.

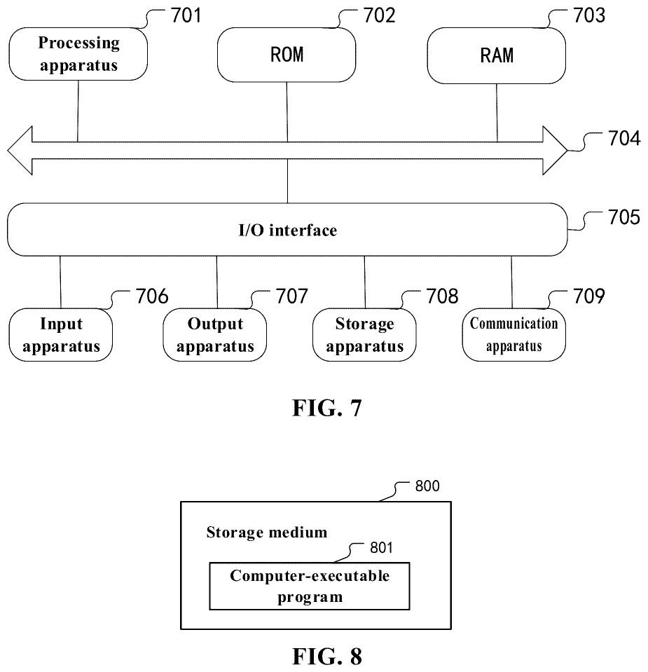

Reference may also be made to FIG. 7, which illustrates a schematic structural diagram of an electronic device 700 suitable for implementing embodiments of the present disclosure. The electronic device 700 shown in FIG. 7 is merely an example, and should not bring any limitation to the functions and usage scopes of the embodiments of the present application.

As shown in FIG. 7, the electronic device 700 may include a processing apparatus (e.g., a central processing unit, a graphics processing unit, or the like) 701. The processing apparatus 701 may be a general-purpose processor, a digital signal processor (DSP), a micro-processor or a micro-controller, and may further include an application specific integrated circuit (ASIC), a field-programmable gate array (FPGA) or other programmable logic devices, a discrete gate or transistor logic device, or a discrete hardware component, which may execute various appropriate actions and processing according to a program stored in a read-only memory (ROM) 702 or a program loaded from a storage apparatus 708 into a random access memory (RAM) 703. In the RAM 703, various programs and data needed by the operations of the electronic device 700 are also stored. The processing apparatus 701, the ROM 702 and the RAM 703 are connected with each other via a bus 704. An input/output (I/O) interface 705 is also connected to the bus 704.

In general, the following apparatuses may be connected to the I/O interface 705: an input apparatus 706, including, for example, a touch screen, a touch pad, a keyboard, a mouse, and the like; an output apparatus 707, including, for example, a liquid crystal display (LCD), a speaker, a vibrator, and the like; the storage apparatus 708, including, for example, a magnetic tape, a hard disk, and the like; and a communication apparatus 709. The communication apparatus 709 may allow the electronic device 700 to communicate in a wireless or wired manner with other devices to exchange data. Although FIG. 7 illustrates the electronic device 700 having various apparatuses, it should be understood that not all illustrated apparatuses are required to be implemented or provided. More or fewer apparatuses may alternatively be implemented or provided. Each block shown in FIG. 7 may represent an apparatus, and may also represent a plurality of apparatuses as needed.

In particular, according to the embodiments of the present application, the processes described above with reference to the flowcharts may be implemented as computer software programs. For example, the embodiments of the present application include a computer program product, which includes a computer program carried on a computer-readable medium, and the computer program contains program codes for executing the method illustrated in the flowcharts. In such embodiments, the computer program may be downloaded and installed from a network via the communication apparatus 709, or installed from the storage apparatus 708, or installed from the ROM 702. When the computer program is executed by the processing apparatus 701, the above functions defined in the code generation method provided in the embodiments of the present application are executed.

An embodiment of the present disclosure further provides a computer-readable storage medium, storing a computer program thereon, wherein when the computer program is executed in a computer, the computer is caused to execute the code generation method shown in FIG. 1 provided in the embodiments of the present application. FIG. 8 is a schematic diagram of a storage medium for implementing the embodiments of the present application. For example, as shown in FIG. 8, the storage medium 800 may be a non-transitory computer-readable storage medium used for storing a non-transitory computer-executable instruction 801. When the non-transitory computer-executable instruction 801 is executed by the processor, the code generation method provided in the embodiments of the present application may be implemented, for example, when the non-transitory computer-executable instruction 801 is executed by the processor, one or more steps in the code generation method provided according to the embodiments of the present application may be executed. For example, the storage medium 800 may be applied to the above electronic device, for example, the storage medium 800 may include a memory in the electronic device. Regarding the description of the storage medium 800, reference may be made to the description of the memory in the embodiment of the electronic device, and thus details are not repeated herein again. Regarding specific functions and technical effects of the storage medium 800, reference may be made to the description of the code generation method provided in the embodiments of the present application, and thus details are not described herein again.

It should be noted that, the computer-readable medium in the embodiments of the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a storage card of a smart phone, a storage component of a tablet computer, a portable computer magnetic disk, a hard disk of a personal computer, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In the embodiments of the present disclosure, the computer-readable storage medium may be any tangible medium that contains or stores a program, wherein the program may be used by or in combination with an instruction execution system, apparatus or device. In the embodiments of the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

The computer-readable medium may be contained in the above electronic device; and it may also be present separately and is not assembled into the electronic device. The computer-readable medium carries one or more programs that, when executed by a server, cause the electronic device to implement the code generation method provided in the embodiments of the present application.

Computer program codes for executing the operations of the embodiments of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or the server. In the case involving the remote computer, the remote computer may be connected to the user computer via any type of network, including a local area network (LAN) or a wide area network (WAN), or it may be connected to an external computer (e.g., via the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment or a code, and the part of the module, the program segment or the code contains one or more executable instructions for implementing specified logic functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions. The units involved in the described embodiments of the present disclosure may be implemented in a software or hardware manner. The names of the units do not constitute limitations of the units themselves in a certain case. The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSP), a system on chip (SOC), a complex programmable logic device (CPLD), and so on.

Various embodiments in the present specification are all described in a progressive manner, the identical or similar parts between the embodiments refer to each other, and what is highlighted in each embodiment is difference with other embodiments. In particular, for the embodiments of the storage medium and the computing device, they are basically similar to the method embodiments, thus are described simply, and for related parts, reference may be made to some descriptions of the method embodiments.

What have been described above are only preferred embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to). In addition, although various operations are described in a particular order, this should not be understood as requiring that these operations are executed in the particular sequence shown or in a sequential order. In certain environments, multitasking and parallel processing may be advantageous. Similarly, although several specific implementation details have been contained in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

The objectives, technical solutions and beneficial effects of the embodiments of the present invention are further described in detail in the above specific implementations. Although the present theme has been described in language specific to structural features and/or methodological actions, it should be understood that the theme defined in the appended claims is not necessarily limited to the specific features or actions described above. Rather, the specific features and actions described above are merely example forms of implementing the claims. It should be understood that the foregoing descriptions are only specific implementations of the embodiments of the present invention, and are not intended to limit the protection scope of the present invention, and any modifications, equivalent replacements, improvements and the like, made on the basis of the technical solutions of the present invention, shall fall within the protection scope of the present invention.

I/We claim:

1. A code generation method, comprising:
in response to opening a first file corresponding to a code to be detected, determining a target element corresponding to a target annotation included in the code to be detected; and
generating a corresponding target code according to the target annotation and the target element.

2. The method according to claim 1, wherein the target element comprises one or more of a class, a method, an attribute and a variable.

3. The method according to claim 1, wherein in response to opening the first file corresponding to the code to be detected comprises: in response to opening the first file corresponding to the code to be detected in an integrated development environment;
the method further comprises:
after generating the target code, storing the target code in a second file; and
refreshing the second file in a virtual file system associated with the integrated development environment.

4. The method according to claim 1, wherein opening the first file corresponding to the code to be detected comprises: opening the first file before the first file is compiled.

5. The method according to claim 1, wherein determining the target element corresponding to the target annotation included in the code to be detected comprises:
according to an abstract syntax tree corresponding to the code to be detected, determining the target element corresponding to the target annotation included in the code to be detected.

6. The method according to claim 1, wherein the first file comprises one or more of a software project file, a software engineering file and a software code file.

7. The method according to claim 1, wherein in response to opening the first file corresponding to the code to be detected comprises: in response to opening the first file corresponding to the code to be detected for the first time.

8. The method according to claim 1, wherein the target annotation is a special marker in the code to be detected.

9. A code generation method, comprising:
in response to a change to a code to be detected, determining whether the change is directed to a target element corresponding to a target annotation; and
in response to the change is directed to the target element corresponding to the target annotation, updating, according to the changed target element, a target code corresponding to the target annotation and the target element.

10. The code generation method according to claim 9, wherein the target element comprises one or more of a class, a method, an attribute and a variable.

11. The code generation method according to claim 9, wherein determining whether the change is directed to a target element corresponding to a target annotation comprising: according to a change event of the code to be detected, determining whether the change is directed to the target element corresponding to the target annotation in the code to be detected.

12. The code generation method according to claim 9, wherein the target annotation is a special marker in the code to be detected.

13. A non-transitory computer-readable storage medium, storing a computer program thereon, wherein when the computer program is executed in a computer, the computer is caused to:
in response to opening a first file corresponding to a code to be detected, determine a target element corresponding to a target annotation included in the code to be detected; and
generate a corresponding target code according to the target annotation and the target element.

14. The non-transitory computer-readable storage medium according to claim 13, wherein the target element comprises one or more of a class, a method, an attribute and a variable.

15. The non-transitory computer-readable storage medium according to claim 13, wherein in response to opening the first file corresponding to the code to be detected comprises: in response to opening the first file corresponding to the code to be detected in an integrated development environment;
the computer is further caused to:
after generating the target code, store the target code in a second file; and
refresh the second file in a virtual file system associated with the integrated development environment.

16. The non-transitory computer-readable storage medium according to claim 13, wherein open the first file corresponding to the code to be detected by: opening the first file before the first file is compiled.

17. The non-transitory computer-readable storage medium according to claim 13, wherein determine the target element corresponding to the target annotation included in the code to be detected by:
according to an abstract syntax tree corresponding to the code to be detected, determine the target element corresponding to the target annotation included in the code to be detected.

18. The non-transitory computer-readable storage medium according to claim 13, wherein the first file comprises one or more of a software project file, a software engineering file and a software code file.

19. The non-transitory computer-readable storage medium according to claim 13, wherein in response to opening the first file corresponding to the code to be detected comprises: in response to opening the first file corresponding to the code to be detected for the first time.

20. The non-transitory computer-readable storage medium according to claim 13, wherein the target annotation is a special marker in the code to be detected.
